(19) United States
(12) Patent Application Publication
(10) Pub. No.: US 2006/0132649 A1
(43) Pub. Date: Jun. 22, 2006

(54) Video signal processing apparatus, video signal processing method, and TV broadcast reception apparatus

(75) Inventor: Hirotoshi Miyazawa, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/221,845

(22) Filed: Sep. 9, 2005

(30) Foreign Application Priority Data
Dec. 20, 2004 (JP) 2004-368212

(51) Int. Cl. H04N 7/01; H04N 5/21

(52) U.S. Cl. 348/458; 348/623; 348/625

(57) ABSTRACT

According to this invention, a video signal processing apparatus inputs an HD video signal or SD up-conversion video signal in an HD format, and includes the first and second second-derivative calculation circuits which respectively calculate the first and second second-derivative signals each of which has a pixel frequency suitable for each signal, an SD/HD video signal detection circuit which detects whether the input video signal is the HD video signal or the SD up-conversion video signal, and a control unit which controls the gain of the first and second second-derivative signals on the basis of the determination result of this SD/HD video signal detection circuit. The gain-controlled first and second second-derivative signals are added to generate a second-derivative signal for contour correction.

### CROSS-REFERENCE TO RELATED APPLICATIONS

This application is based upon and claims the benefit of priority from prior Japanese Patent Application No. 2004-368212, filed Dec. 20, 2004, the entire contents of which are incorporated herein by reference.

### BACKGROUND OF THE INVENTION

1. Field of the Invention

The present invention relates to a video signal processing apparatus, video signal processing method, and TV broadcast reception apparatus for performing contour correction of an HD-format video signal transmitted in BS digital broadcast or the like.

2. Description of the Related Art

In BS digital broadcast, two types of HD-format videos are transmitted. One is a normal HD video with an aspect ratio of 16:9, and the other is a video obtained by up-converting an SD video with an aspect ratio of 4:3 in conventional NTSC broadcast into the HD video and adding side panel portions at right and left of the converted video. When image quality correction for the HD video is performed for the latter SD up-conversion video, an intended image quality correction effect cannot be obtained. That is, when a conventional horizontal/vertical contour correction circuit is used for the SD up-conversion video, the video with only an SD frequency bandwidth is input to the contour correction circuit in which a peak frequency is set to be optimum for the HD video. That is, since the set peak frequency is too high for the SD video, the desired correction effect cannot be obtained.

Hence, the image quality correction apparatus disclosed in Jpn. Pat. Appln. KOKAI Publication No. 2003-143439 includes a circuit which determines whether the original video of the HD-format video is the SD or HD video, and a selector which switches image quality correction on and off in accordance with the determination result. Accordingly, image quality correction optimum for the SD and HD video frequency bandwidths can be performed.

However, in the image quality correction apparatus disclosed in Jpn. Pat. Appln. KOKAI Publication No. 2003-143439, an exclusive selector circuit is prepared for switching image quality correction on and off in the SD or HD video image quality correction circuit to completely perform the switching operation. Accordingly, the correction results of both circuits cannot be used at the same time.

### BRIEF SUMMARY OF THE INVENTION

According to an aspect of the present invention, a video signal processing apparatus comprises a first second-derivative calculation circuit configured to calculate a first second-derivative signal having a first peak frequency, in accordance with an HD video signal input as an HD-format signal, a second second-derivative calculation circuit configured to calculate a second second-derivative signal having a second peak frequency, in accordance with an SD up-conversion video signal input as the HD-format signal, an SD/HD video signal detection circuit configured to detect whether an original video signal of the input HD-format signal is one of the SD up-conversion video signal and the HD video signal, a gain control unit configured to control a gain for the first second-derivative signal and the second second-derivative signal on the basis of a determination result of the SD/HD video signal detection circuit, an addition circuit configured to add the first second-derivative signal and the second second-derivative signal which are controlled by the gain control unit, a nonlinear processing unit configured to perform an amplitude limitation process and a coring process for the second-derivative signal output from the addition circuit, and control a gain of the second-derivative signal on the basis of a predetermined gain coefficient, and an output unit configured to output a video signal which has undergone contour correction by adding the second-derivative signal processed by the nonlinear processing unit and the input HD-format signal.

According to another aspect of the present invention, a video signal processing method comprises a first second-derivative calculation step of calculating a first second-derivative signal having a first peak frequency, in accordance with an HD video signal input as an HD-format signal, a second second-derivative calculation step of calculating a second second-derivative signal having a second peak frequency, in accordance with an SD up-conversion video signal input as the HD-format signal, an SD/HD video signal detection step of detecting whether an original video signal of the input HD-format signal is one of the SD up-conversion video signal and the HD video signal, a gain control step of controlling a gain for the first second-derivative signal and the second second-derivative signal on the basis of a determination result of the SD/HD video signal detection circuit, an addition step of adding the first second-derivative signal and the second second-derivative signal which are controlled in the gain control step, a nonlinear processing step of performing an amplitude limitation process and a coring process for the second-derivative signal output in the addition step, and controlling a gain of the second-derivative signal on the basis of a predetermined gain coefficient, and an output step of outputting a video signal which has undergone contour correction by adding the second-derivative signal processed in the nonlinear processing step and the input HD-format signal.

According to still another aspect of the present invention, a TV broadcast reception apparatus comprises a reception demodulation unit configured to receive a TV broadcast signal, and demodulate the TV broadcast signal into a video signal, a video signal processing unit configured to process the demodulated video signal, and a display unit configured to display the processed video signal, the video signal processing unit comprising a first second-derivative calculation circuit configured to calculate a first second-derivative signal having a first peak frequency, in accordance with an HD video signal input as an HD-format signal, a second second-derivative calculation circuit configured to calculate a second second-derivative signal having a second peak frequency, in accordance with an SD up-conversion video signal input as the HD-format signal, an SD/HD video signal detection circuit configured to detect whether an original video signal of the input HD-format signal is one of the SD up-conversion video signal and the HD video signal, a gain control unit configured to control a gain for the first second-derivative signal and the second second-derivative signal on the basis of a determination result of the SD/HD video signal detection circuit, an addition circuit configured to add the first second-derivative signal and the second second-derivative signal which are controlled by the gain control unit, a nonlinear processing unit configured to perform an amplitude limitation process and a coring process for the second-derivative signal output from the addition circuit, and control a gain of the second-derivative signal on the basis of a predetermined gain coefficient, and an output unit configured to output a video signal which has undergone contour correction by adding the second-derivative signal processed by the nonlinear processing unit and the input HD-format signal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a video signal processing apparatus according to an embodiment of the present invention;

FIG. 2 is a graph showing an example of the input/output characteristics of a nonlinear processing unit shown in FIG. 1;

FIG. 3 is a block diagram showing an example of an SD/HD video signal detection circuit shown in FIG. 1;

FIG. 4 is a view for explaining an example of the operation of the apparatus shown in FIG. 1;

FIG. 5 is a graph for explaining an example of the operation of the apparatus shown in FIG. 1;

FIG. 6 is a flowchart showing a case where a system equivalent to that shown in FIG. 1 is implemented by software;

FIG. 7 is a block diagram showing a TV broadcast reception apparatus to which the video signal processing apparatus is applied according to the embodiment of the present invention; and

FIG. 8 is a block diagram showing an example of the arrangement of the video signal processing apparatus shown in FIG. 7.

### DETAILED DESCRIPTION OF THE INVENTION

An embodiment of the present invention will be described below with reference to the accompanying drawing.

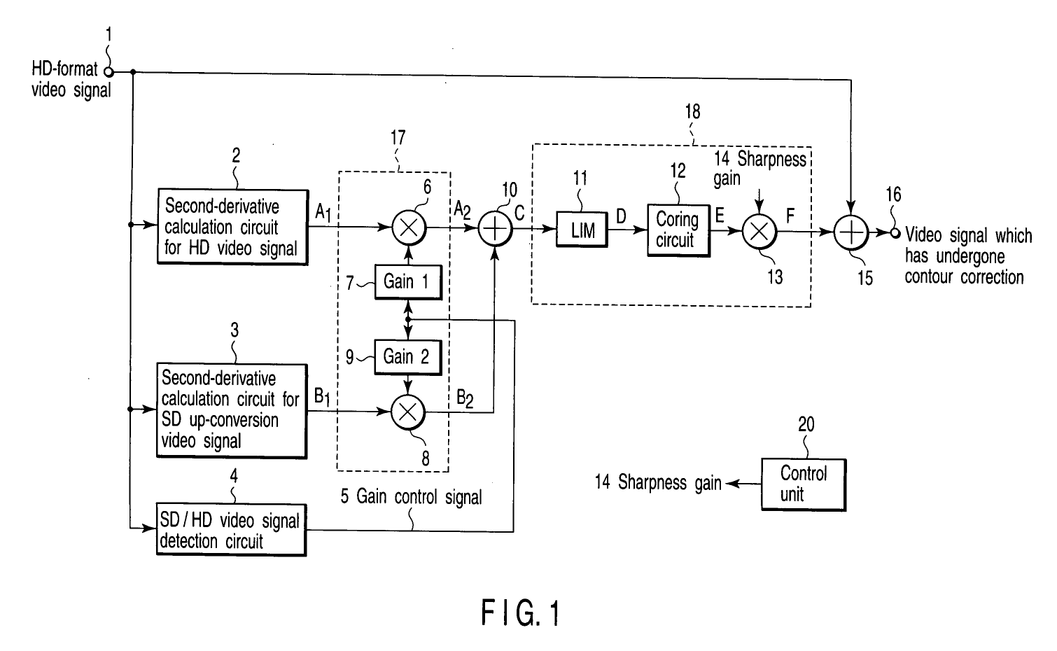

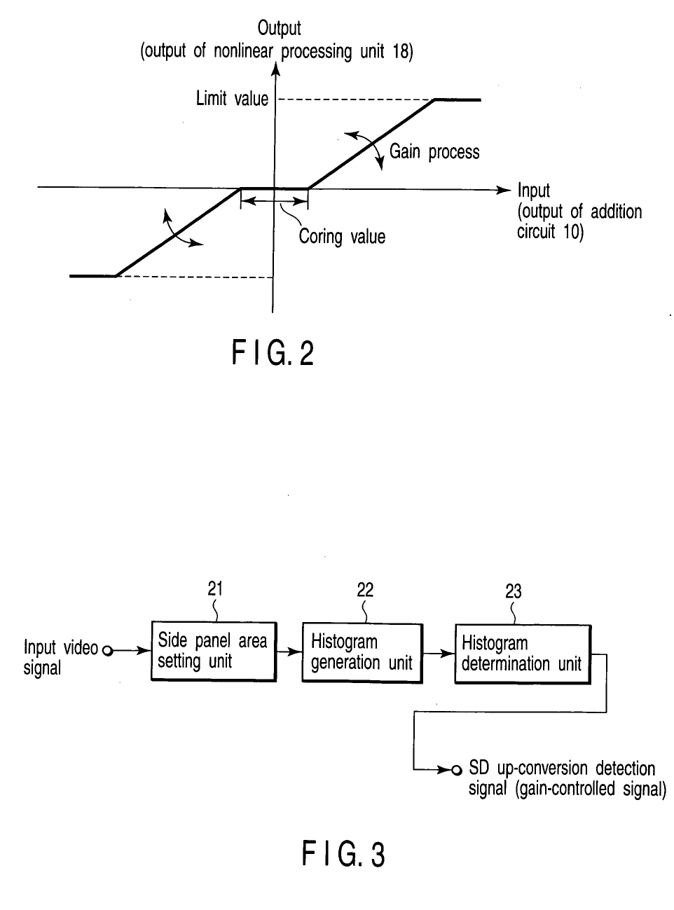

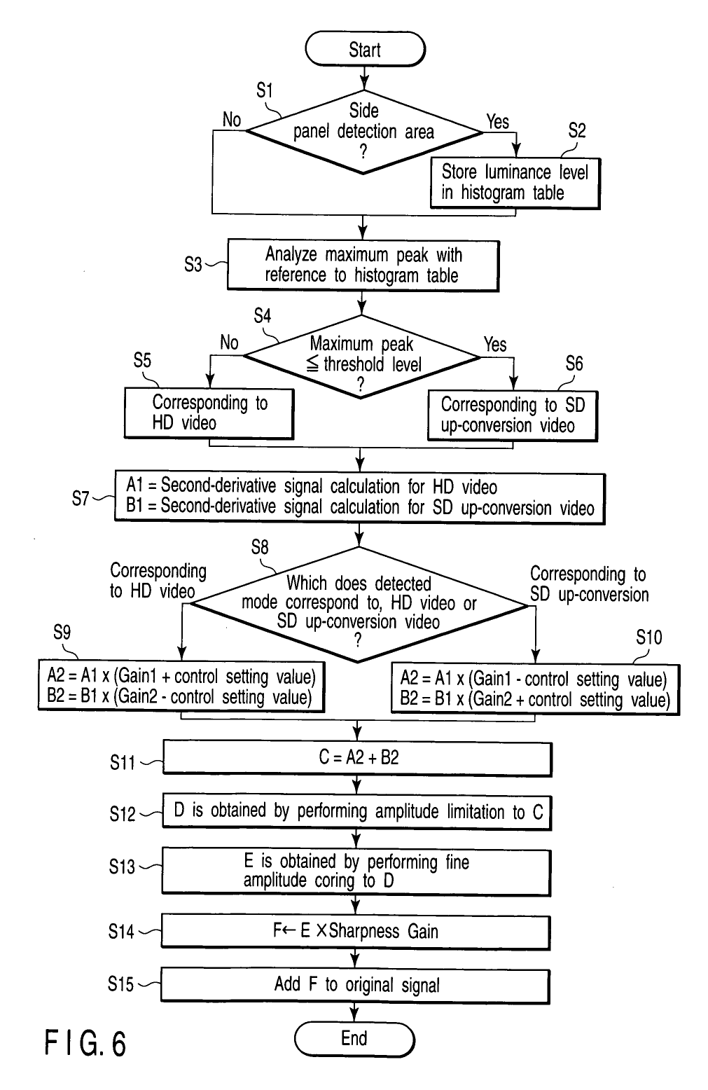

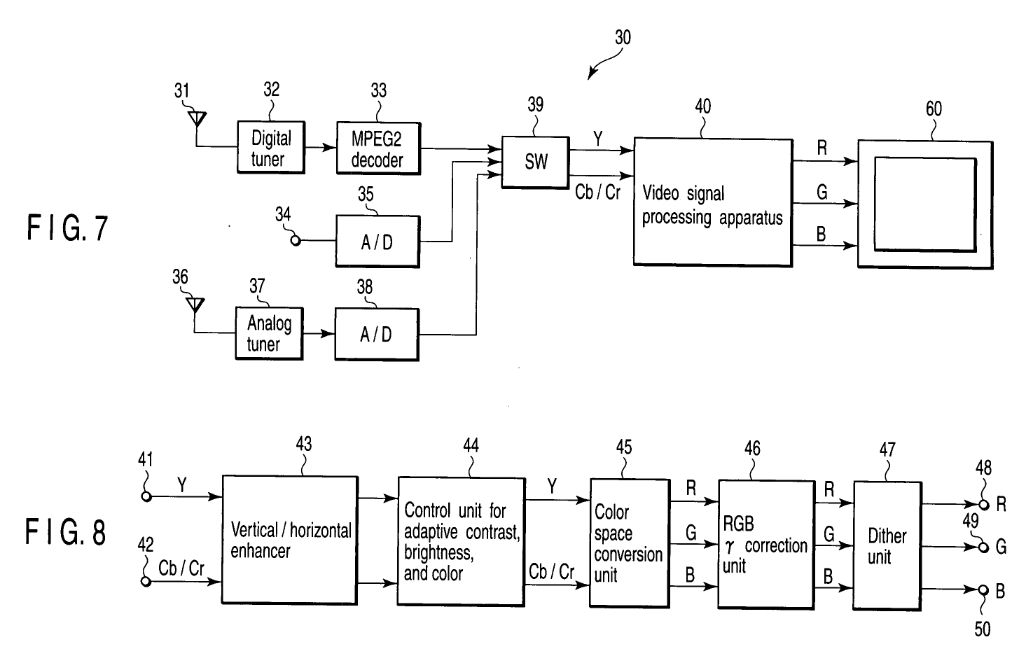

FIG. 1 is a block diagram showing a video signal processing apparatus according to an embodiment of the present invention. FIGS. 2 to 5 are views for explaining the operation of the apparatus shown in FIG. 1. FIG. 6 is a flowchart showing a case where a system equivalent to that shown in FIG. 1 is implemented by software. FIG. 7 is a block diagram showing a TV broadcast reception apparatus to which the video signal processing apparatus is applied according to the present invention. FIG. 8 is a block diagram showing the arrangement of the video signal processing apparatus shown in FIG. 7.

First, the embodiment will be described with reference to FIGS. 7 and 8.

A TV broadcast reception apparatus shown in FIG. 7 is a TV set capable of receiving digital and analog broadcast programs. A digital TV signal received by a digital TV reception antenna 31 is received by a digital tuner 32, and demodulated into an MEPG2 signal. After that, this MPEG2 signal is decoded by an MPEG2 decoder 33, and the decoded MPEG2 signal is output as a luminance signal Y and color signals Cb/Cr.

An analog TV signal received by an analog TV reception antenna 36 is received by an analog tuner 37, and decoded into the luminance signal Y and the color signals Cb/Cr. After that, this demodulated signal is supplied to an A/D conversion unit 38, and output as the digital luminance signal Y and color signals Cb/Cr.

Alternatively, an Y/C-separated signal and a component signal which are played back by an external device such as a VTR or a DVD recorder (not shown) and output to an external input terminal 34 are supplied to an A/D conversion unit 35, and output as the digital luminance signal Y and color signals Cb/Cr.

These three signals, i.e., luminance signal Y and color signals Cb/Cr output from the MPEG2 decoder 33 and the A/D conversion units 35 and 38 are respectively connected to three input terminals of a switching unit (to be abbreviated as SW hereinafter) 39 serving as a video switching circuit. The switching unit 39 selects one of the input signals upon user's switching operation. One of the luminance signal Y and color signals Cb/Cr selected by the switching unit 39 is processed by the video signal processing apparatus 40, and then output as R, G, or B signals. The output signals are displayed on the window of a digital display device 60 serving as an output device. As the digital display device 60, a flat-panel display such as a liquid crystal display or a plasma display is available.

As shown in FIG. 8, the video signal processing apparatus 40 includes a vertical/horizontal enhancer 43, a control unit 44 for adaptive contrast, brightness, and color, a color space conversion unit 45, an RGB γ correction unit 46, and a dither unit 47. Upon reception of one of the luminance signal Y and the color signals Cb/Cr, the vertical/horizontal enhancer 43 makes the leading edge of the signal steeper, or changes the sharpness of the signal. The control unit 44 for adaptive contrast, brightness, and color performs γ correction of the luminance signal Y, and amplitude control of the color signals on the basis of γ correction. The color space conversion unit 45 converts the luminance signal Y and the color signals Cb/Cr into the R, G, and B signals. The RGB γ correction unit 46 performs γ correction of the R, G, and B signals, and white balance adjustment for the output device. The dither unit 47 performs a compression process of converting a high-tone bit expression obtained by extending a bit count in order to increase an expressive power in the former stage, into a low-tone bit count suitable for the output device in the latter stage.

In FIGS. 1 to 6 according to the embodiment of the present invention described below, a horizontal contour correction circuit used in the vertical/horizontal enhancer 43 of the video signal processing apparatus 40 will be described.

The horizontal contour correction circuit shown in FIG. 1 includes a first second-derivative calculation circuit 2, second second-derivative calculation circuit 3, SD/HD video signal detection circuit 4, gain control means 17, addition circuit 10, nonlinear processing unit 18, and addition circuit 15. The first second-derivative calculation circuit 2 calculates the first second-derivative signal having the first peak frequency (e.g., 18 MHz), in accordance with the HD video signal input as an HD-format video signal from an input terminal 1. The second second-derivative calculation circuit 3 calculates the second second-derivative signal having the second peak frequency (e.g., 9 MHz) lower than the first peak frequency, in accordance with the SD up-conversion video signal input as the HD-format video signal from the input terminal 1. The SD/HD video signal detection circuit 4 detects whether the original video of the HD-format video signal input from the input terminal 1 is the SD or HD video signal. The gain control means 17 controls the gain for the first and second second-derivative signals, on the basis of the determination result of the SD/HD video signal detection circuit 4. The addition circuit 10 adds the first and second second-derivative signals which have undergone gain control. The nonlinear processing unit 18 performs an amplitude limitation process and a coring process for the second-derivative signal output from the addition circuit 10, and then controls the gain of the second-derivative signal on the basis of a predetermined gain coefficient. The addition circuit 15 adds the second-derivative signal which has undergone the nonlinear process to the video signal input to the input terminal 1, and outputs the video signal which has undergone the contour correction process. In addition, a control unit 20 for controlling each part of the horizontal contour correction circuit, and supplying the gain coefficient to the multiplication circuit 13 of the nonlinear processing unit 18 is provided. As the control unit 20, for example, a microprocessor is available. The arrangement of each part of the horizontal contour correction circuit will be described in more detail below.

The HD-format video signal input from the input terminal 1 is the HD video signal or the SD up-conversion video signal.

The first second-derivative calculation circuit 2 calculates the first second-derivative signal with the peaking characteristics of the first peak frequency (18 MHz) suitable for the video frequency bandwidth of the HD video signal input to the input terminal 1.

The second second-derivative calculation circuit 3 calculates the second second-derivative signal with the peaking characteristics of the second peak frequency (9 MHz) suitable for the video frequency bandwidth of the SD up-conversion video signal input to the input terminal 1.

The gain control means 17 includes a multiplication circuit 6 and a gain setting unit 7. The multiplication circuit 6 includes the first gain control unit for multiplying the first second-derivative signal from the first second-derivative calculation circuit 2 by a gain setting value Gain1 from the gain setting unit 7, and outputting the resultant signal. The gain control means 17 also includes a multiplication circuit 8 and a gain setting unit 9. The multiplication circuit 8 includes a second gain control unit for multiplying the second second-derivative signal from the second second-derivative calculation circuit 3 by a gain setting value Gain2 from the gain setting unit 9, and outputting the resultant signal. The first and second gain setting units 7 and 9 receive the detection result as a gain control signal from the SD/HD video signal detection circuit 4, thereby switching between the gain setting values Gain1 and Gain2 of the first and second gain setting units 7 and 9.

When the SD/HD video signal detection circuit 4 detects the HD video signal, the gain setting value Gain1 is increased, and the gain setting value Gain2 is decreased (to, e.g., 0 or about 0), thereby lessening or nullifying the effect of the second-derivative signal suitable for the SD up-conversion video. When the SD/HD video signal detection circuit 4 detects the SD up-conversion video signal, the gain setting value Gain1 is decreased (to, e.g., 0 or about 0), and the gain setting value Gain2 is increased, thereby lessening or nullifying the effect of the second-derivative signal suitable for the HD video signal.

The nonlinear processing unit 18 includes a limitter circuit 11 which limits the amplitude of the second-derivative signal having a large amplitude, a coring circuit 12 for coring the high-frequency noise component having a small amplitude, and a multiplication circuit 13 which performs gain adjustment on the basis of a sharpness gain 14. The nonlinear processing unit 18 performs a nonlinear process for the second-derivative signal from the addition circuit 10, and applies the processed signal to the addition circuit 15. In this case, the coring circuit 12 eliminates the noise component having the small amplitude of the contour component by coring, at a predetermined coring value, the second-derivative signal from the addition circuit 10 which corresponds to the contour component of the input video signal.

FIG. 2 shows input/output characteristics of the nonlinear processing unit 18 in the horizontal contour correction circuit shown in FIG. 1.

For example, the SD/HD video signal detection circuit 4 can be a side panel detection circuit which detects whether the input video signal is the SD up-conversion video signal.

FIG. 3 shows the side panel detection circuit serving as the example of the SD/HD video signal detection circuit 4. The side panel detection circuit includes a side panel area setting unit 21, histogram generation unit 22, and histogram determination unit 23. The side panel area setting unit 21 samples the luminance signal by 240 pixels at each side of 1,920 horizontal effective pixels of the SD up-conversion video signal. The histogram generation unit 22 generates a histogram which indicates the distribution at each luminance level of the sampling pixels in an area set by the side panel area setting unit 21. The histogram determination unit 23 determines whether the maximum peak luminance level is equal to or lower than a preset threshold level with reference to the generated histogram. Accordingly, it is determined whether the input video signal is the SD up-conversion video signal.

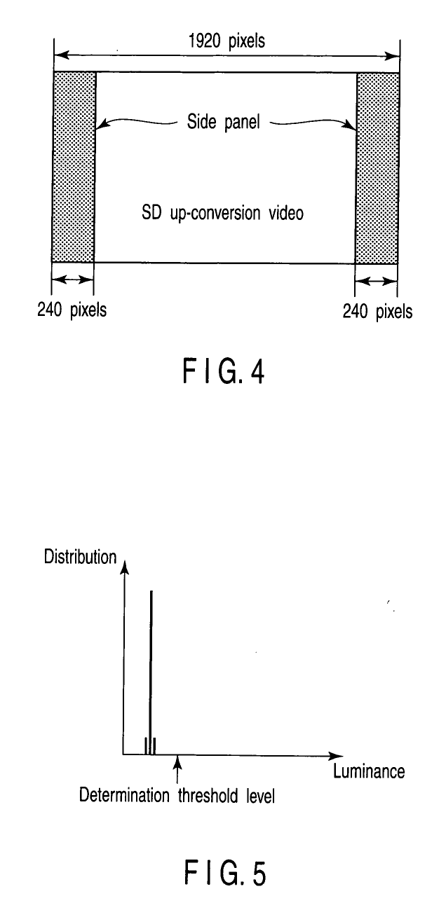

FIGS. 4 and 5 are views for explaining an example of the detection method of the SD up-conversion video signal with an aspect ratio of 16:9. FIG. 4 shows the SD up-conversion video signal with an aspect ratio of 16:9, and FIG. 5 shows the histogram indicating the distribution at each luminance level of the SD up-conversion video signal.

The HD-format SD up-conversion video signal with an aspect ratio of 16:9 is generally obtained by adding the side panels at both sides of the video portion with an aspect ratio of 4:3 conventionally used in NTSC broadcast. Usually, the side panel signal is a black stripe or dark signal. Hence, the side panel detection circuit samples the luminance signal by 240 pixels at each side of the 1,920 horizontal effective pixels of the HD-format SD up-conversion video signal, and counts the distribution at each luminance level by 240 pixels at each side to make a graph. That is, as shown in FIG. 5, the histogram in which abscissa and ordinate respectively represent the luminance level and the distribution is generated.

In accordance to this, when it is determined that the both sides of the window are uniformly dark, only one peak is present in the histogram. Hence, the maximum peak is equal to or lower than the luminance level (=threshold level) set for determination of the luminance level. As a result, it can be determined that the input video signal is the SD up-conversion video signal.

Next, the operation of the apparatus shown in FIG. 1 will be described. The HD-format video signal received by the input terminal 1 is output to the second-derivative calculation circuit 2 for the HD video signal, and the second-derivative calculation circuit 3 for the SD up-conversion video signal. Each of the second-derivative calculation circuit 2 for the HD video signal and the second-derivative calculation circuit 3 for the SD up-conversion video signal is the second-derivative calculation circuit in which the peak frequency is independently set. The gain adjustment process is performed in each of the multiplication circuits capable of independently setting the gain, i.e., the multiplication circuit 6 for the HD video signal and the multiplication circuit 8 for the SD up-conversion video signal. After that, the two signals which have undergone gain adjustment are input to the addition circuit 10, and synthesized. Then, amplitude limitation is performed by the limitter circuit 11 which limits the contour correction effect for the second-derivative signal with the large amplitude, and the coring circuit 12 which eliminates the small amplitude such as the noise. The signal which has undergone amplitude limitation is input to the multiplication circuit 13. The multiplication circuit 13 multiplies the input signal and a setting value (Sharpness Gain) for determining a contour correction effect amount for the original signal. The addition circuit 15 adds the multiplication result to the input video signal serving as the original signal from the input terminal 1. The resultant signal is then output as the video signal which has undergone contour correction, to the operation unit 16.

In this case, in order to change the weights of the two peak frequencies, the gain setting value Gain1 of the gain setting unit 7 and the gain setting value Gain2 of the gain setting unit 9 must be controlled.

The HD-format input video signal from the input terminal 1 is output to the SD/HD video signal detection circuit 4. The detection result is output as a gain control signal 5. The gain setting unit 7 and the gain setting unit 9 receive the gain control signal 5. When it is detected that the input video signal is the HD video signal, the gain setting value Gain1 is increased, and the gain setting value Gain2 is decreased, thereby lessening or nullifying the effect of the second-derivative signal suitable for the SD up-conversion video signal. Alternatively, when it is detected that the input video signal is the SD up-conversion video signal, the gain setting value Gain1 is decreased, and the gain setting value Gain2 is increased, thereby lessening or nullifying the effect of the second-derivative signal suitable for the HD video signal.

As described above, in the present invention, the second-derivative calculation circuit 2 for the HD video and the second-derivative calculation circuit 3 for the SD up-conversion video each of which has two independent peak frequencies are constructed. In addition to this, gain adjustment is independently performed for the second-derivative signals in the multiplication circuits 6 and 8. By gain control, optimum control can be performed for each video, and optimum control can also be implemented by parameter control of gain control without using the conventional exclusive selector, thereby implementing the video suitable for an LSI arrangement.

Upon parameter control, contour correction optimum for the input SD up-conversion video can be performed. In order to implement this contour correction process, the following processes are executed. First, it is determined that the input image is the SD up-conversion video upon detection of the side panels. When it is determined that the input image is the SD up-conversion video in accordance with the determination result, the gain for the second-derivative signal for the HD video is decreased in accordance with the gain control signal 5, and the gain for the second-derivative signal for the SD up-conversion video is increased.

According to the present invention, when the HD video or the SD up-conversion video is input, the circuit itself can quickly switch the peak frequency suitable for each video.

FIG. 6 shows a flowchart showing a case where a system equivalent to that shown in FIG. 1 is implemented by software. Reference symbols A1 to F correspond to the signals of the parts shown in FIG. 1.

First, in the side panel detection process, it is determined whether the input video signal is in the side panel detection area (step S1). If YES in step S1, the luminance level is stored in a histogram table, and a histogram indicating the distribution at each luminance level is generated (step S2).

After that, the maximum peak is analyzed with reference to the histogram (step S3), and it is determined whether the maximum peak is equal to or lower than the threshold level (step S4). If NO in step S4, it is determined that the input video signal corresponds to the HD video signal (step S5). If YES in step S4, it is determined that the input video signal corresponds to the SD up-conversion video signal (step S6). Note that reference symbol A1 denotes the second-derivative signal calculation result for the HD video, and reference symbol B1 denotes the second-derivative signal calculation result for the SD up-conversion video (step S7).

In the gate control process, it is checked whether the detected input video signal mode corresponds to the HD video or the SD up-conversion video (step S8). If the input video signal mode corresponds to the HD video, the product of the HD video second-derivative signal A1 and the gain obtained as a sum of the gain setting value Gain1 and the control setting value (value based on the gain control signal 5) is given as a signal A2, and the product of the SD up-conversion video second-derivative signal B1 and the gain obtained by subtracting the control setting value (value based on the gain control signal 5) from the gain setting value Gain2 (step S9) is given as a signal B2.

If the input video signal mode corresponds to the SD up-conversion video, the product of the HD video second-derivative signal A1 and the gain obtained by subtracting the control setting value (value based on gain control signal 5) from the gain setting value Gain1 is given as the signal A2, and the product of the SD up-conversion video second-derivative signal B1 and the gain as a sum of the gain setting value Gain2 and the control setting value (value based on the gain control signal 5) is given as the signal B2 (step S10).

Also, the sum of the signals A2 and B2 is given as a signal C (step S11), and a signal D is obtained by performing amplitude limitation for the addition signal C (step S12). Furthermore, a fine amplitude coring process is performed for the signal D to obtain a signal E (step S13). A contour correction signal F is the product of the signal E and the sharpness gain (step S14). After that, the video signal which has undergone contour correction optimum for the input image can be obtained by adding the input video signal from input terminal 1 and the contour correction signal F.

Note that in the above-described embodiment, horizontal contour correction is performed. However, vertical contour correction can also be performed in a similar arrangement.

As described above, the video signal processing apparatus, video signal processing method, and TV broadcast reception apparatus in the embodiment of the present invention can control the gains obtained by the correction results of the HD video and the SD up-conversion video. By using the gain-controlled correction results, optimum adjustment can be performed.

The present invention can be effective for, e.g., a video device including a TV set or a video signal recording/playback apparatus for performing the correction process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video signal processing apparatus comprising:
a first second-derivative calculation circuit configured to calculate a first second-derivative signal having a first peak frequency, in accordance with an HD video signal input as an HD-format signal;
a second second-derivative calculation circuit configured to calculate a second second-derivative signal having a second peak frequency, in accordance with an SD up-conversion video signal input as the HD-format signal;
an SD/HD video signal detection circuit configured to detect whether an original video signal of the input HD-format signal is one of the SD up-conversion video signal and the HD video signal;
a gain control unit configured to control a gain for the first second-derivative signal and the second second-derivative signal on the basis of a determination result of the SD/HD video signal detection circuit;
an addition circuit configured to add the first second-derivative signal and the second second-derivative signal which are controlled by the gain control unit;
a nonlinear processing unit configured to perform an amplitude limitation process and a coring process for the second-derivative signal output from the addition circuit, and control a gain of the second-derivative signal on the basis of a predetermined gain coefficient; and
an output unit configured to output a video signal which has undergone contour correction by adding the second-derivative signal processed by the nonlinear processing unit and the input HD-format signal.

2. An apparatus according to claim 1, wherein the gain control unit controls to decrease the gain for the first second-derivative signal for the HD video and increase the gain for the second second-derivative signal for the SD up-conversion video on the basis of a gain control signal when it is determined in accordance with a determination result of the SD/HD video signal detection circuit that the original video signal of the input HD-format signal is the SD up-conversion video signal, controls to increase the gain for the first second-derivative signal for the HD video and decrease the gain for the second second-derivative signal for the SD up-conversion video on the basis of the gain control signal when it is determined in accordance with the determination result of the SD/HD video signal detection circuit that the original video signal of the input HD-format signal is the HD video signal, and performs optimum contour correction in accordance with the input video signal.

3. An apparatus according to claim 1, wherein the gain control unit comprises
a first gain setting unit configured to set a first gain setting value,
a first multiplication circuit configured to multiply the first second-derivative signal from the first second-derivative calculation circuit by the first gain setting value set by the first gain setting unit,
a second gain setting unit configured to set a second gain setting value, and
a second multiplication circuit configured to multiply the second second-derivative signal from the second second-derivative calculation circuit by the second gain setting value set by the second gain setting unit,
each of the first gain setting unit and the second gain setting unit receiving a detection result from the SD/HD video signal detection circuit as a gain control signal, and switching the first gain setting value and the second gain setting value on the basis of the gain control signal.

4. An apparatus according to claim 1, wherein the SD/HD video signal detection circuit comprises
a side panel area setting unit configured to sample and set a luminance signal by a predetermined pixel count at each side area of horizontal effective pixel count of the SD up-conversion video signal,
a histogram generation unit configured to generate a histogram indicating a distribution at each luminance level of the sampled pixels in the area set by the side panel area setting unit, and
a histogram determination unit configured to determine whether the input signal is the SD up-conversion video signal by determining whether the luminance level having a maximum peak is not more than a threshold level set in advance, with reference to the generated histogram.

5. A video signal processing method comprising:
a first second-derivative calculation step of calculating a first second-derivative signal having a first peak frequency, in accordance with an HD video signal input as an HD-format signal;
a second second-derivative calculation step of calculating a second second-derivative signal having a second peak frequency, in accordance with an SD up-conversion video signal input as the HD-format signal;
an SD/HD video signal detection step of detecting whether an original video signal of the input HD-format signal is one of the SD up-conversion video signal and the HD video signal;
a gain control step of controlling a gain for the first second-derivative signal and the second second-derivative signal on the basis of a determination result of the SD/HD video signal detection step;
an addition step of adding the first second-derivative signal and the second second-derivative signal which are controlled in the gain control step;
a nonlinear processing step of performing an amplitude limitation process and a coring process for the second-derivative signal output in the addition step, and controlling a gain of the second-derivative signal on the basis of a predetermined gain coefficient; and
an output step of outputting a video signal which has undergone contour correction by adding the second-derivative signal processed in the nonlinear processing step and the input HD-format signal.

6. A TV broadcast reception apparatus comprising:
a reception demodulation unit configured to receive a TV broadcast signal, and demodulate the TV broadcast signal into a video signal;
a video signal processing unit configured to process the demodulated video signal; and
a display unit configured to display the processed video signal,
the video signal processing unit comprising
a first second-derivative calculation circuit configured to calculate a first second-derivative signal having a first peak frequency, in accordance with an HD video signal input as an HD-format signal,
a second second-derivative calculation circuit configured to calculate a second second-derivative signal having a second peak frequency, in accordance with an SD up-conversion video signal input as the HD-format signal,
an SD/HD video signal detection circuit configured to detect whether an original video signal of the input HD-format signal is one of the SD up-conversion video signal and the HD video signal,
a gain control unit configured to control a gain for the first second-derivative signal and the second second-derivative signal on the basis of a determination result of the SD/HD video signal detection circuit,
an addition circuit configured to add the first second-derivative signal and the second second-derivative signal which are controlled by the gain control unit,
a nonlinear processing unit configured to perform an amplitude limitation process and a coring process for the second-derivative signal output from the addition circuit, and control a gain of the second-derivative signal on the basis of a predetermined gain coefficient, and
an output unit configured to output a video signal which has undergone contour correction by adding the second-derivative signal processed by the nonlinear processing unit and the input HD-format signal.

7. An apparatus according to claim 6, wherein the gain control unit controls to decrease the gain for the first second-derivative signal for the HD video and increase the gain for the second second-derivative signal for the SD up-conversion video on the basis of a gain control signal when it is determined in accordance with a determination result of the SD/HD video signal detection circuit that the original video signal of the input HD-format signal is the SD up-conversion video signal, controls to increase the gain for the first second-derivative signal for the HD video and decrease the gain for the second second-derivative signal for the SD up-conversion video on the basis of the gain control signal when it is determined in accordance with the determination result of the SD/HD video signal detection circuit that the original video signal of the input HD-format signal is the HD video signal, and performs optimum contour correction in accordance with the input video signal.
